(19) United States
(12) Patent Application Publication
(10) Pub. No.: US 2008/0062690 A1
(43) Pub. Date: Mar. 13, 2008

(54) Lighting device with protective cover

(76) Inventor: T. Y. Ip, Kowloon (HK)

Correspondence Address: ERIC HANSCOM, 7395 PORTAGE WAY, CARLSBAD, CA, 92011, US

(21) Appl. No.: 11/516,965

(22) Filed: Sep. 8, 2006

(51) Int. Cl. F21V 23/04; F21V 1/00

(52) U.S. Cl. 362/251; 362/235

(57) ABSTRACT

A light device includes a base portion, a light portion attached to the base portion, at least one light emitting element, a power supply electrically connected to the at least one light emitting element, and a protective cover coupled to the base portion. The protective cover defines an interior region wherein the base portion is disposed. The protective cover is preferably substantially translucent and can be comprised of a strong and durable material to allow the light device to serve as a weight-bearing device. The light device can include a control circuit to allow a user to manually vary the color and duration of the light emitted from the light emitting element. The light device can be used to within a walkway, a fireplace, a wall, or as a stepping stone. The light device can plug into a standard wall outlet, be solar powered, or be battery powered.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF INVENTION

1. Field of the Invention

The embodiments of the invention relate to the field of decorative lights. More specifically, the embodiments of the present invention relate to light devices for both indoor and outdoor use.

2. Description of the Related Art

Since the event of the light bulb, people have attempted to find new and unique ways to create festive atmospheres, both indoor and outdoor, through the use of lighting. For example, decorative lights have been placed on top of furniture, in ceilings, on walls, in rooms, and in several other locations within the home. Lights have also been placed next to walkways and hung from patio covers and gazebos to provide a more festive outdoor setting. With regard to outdoor lighting in particular, many outdoor lights have limited decorative capabilities due to the fragile nature of the lights and associated light bulbs. Further, many outdoor lights are prone to quick wear and deterioration due to designs that are not able to withstand outdoor elements such as freezing temperatures, heavy rain or snow, high winds, and dust and other airborne particles. Still further, many outdoor lights are prone to damage and breakage from inadvertent contact from animals and persons engaged in outdoor activity.

Most current decorative lights are generally constructed with plain bulbs and simple lampshades. These lights, while providing great functional aspects, often lack in originality of construction and in light source. Additionally, the prior art decorative lights have not been able to satisfy the increasing consumer demand for aesthetic perception in the visual effect that is in-tune with the surrounding visual atmosphere. Further, prior art lighting devices are generally limited to providing one feature—lighting. Most lighting devices do not offer a utilitarian function that is beneficial to a consumer, thereby limiting the value of the device to a consumer.

Therefore, there is a current need for a lighting device that can provide a festive indoor and outdoor atmosphere that is convenient to use, can withstand outdoor elements such as freezing temperatures, rain and snow, high winds, and dust, is aesthetically pleasing, can provide a utilitarian purpose other than lighting, can withstand significant physical contact without being damaged, and that utilizes new and improved lighting techniques.

In this respect, before explaining at least one embodiment of the invention in detail it is to be understood that the embodiments of the invention are not limited in their application to the details of construction and to the arrangement of the components set forth in the following description or illustrated in the drawings. The embodiments of the invention are capable of being practiced and carried out in various ways. In addition, it is to be understood that the phraseology and terminology employed herein are for the purpose of description and should not be regarded as limiting.

### BRIEF SUMMARY OF THE EMBODIMENTS OF THE INVENTION

The preferred embodiment of the invention provides a lighting device comprising a base portion, a light portion attached to the base portion, at least one light emitting element, a power supply electrically connected to the at least one light emitting element, and a protective cover coupled to the base portion. The protective cover defines an interior region wherein the base portion is disposed. The protective cover is preferably substantially translucent and can be comprised of a strong and durable material to allow the light device to serve as a weight-bearing device. The light device can be used to within a walkway, a fireplace, a wall, or as a stepping stone. The light device can plug into a standard wall outlet, be solar powered, or be battery powered.

Another embodiment of the invention provides a lighting device comprising a base portion, a light portion attached to the base portion, at least one light emitting element, a power supply electrically connected to the at least one light emitting element, and a protective cover coupled to the base portion. The protective cover defines an interior region wherein the base portion is disposed. The protective cover is preferably substantially translucent and can be comprised of a strong and durable material to allow the light device to serve as a weight-bearing device. The light device can be used to within a walkway, a fireplace, a wall, or as a stepping stone. The light device can plug into a standard wall outlet, be solar powered, or be battery powered.

The lighting device further includes a control circuit to allow a user to manually vary the color and duration of the light emitted from the light emitting element. A flashing control circuit is connected between the circuitry and the light portion. The flashing control circuit controls the light spots emitted by lighting elements. The flashing control circuit can automatically be set to cause the light to flash in various preset flashing patterns or remain constant. The flashing control circuit can also be manually set to allow the operator to modify the timing of the flashing.

Another embodiment of the invention provides a lighting device comprising a base portion, a light portion attached to the base portion, at least one light emitting element, a power supply electrically connected to the at least one light emitting element, and a protective cover coupled to the base portion. The protective cover defines an interior region wherein the base portion is disposed.

The protective cover is preferably substantially translucent and can be comprised of a strong and durable material to allow the light device to serve as a weight-bearing device. The light device can be used to within a walkway, a fireplace, a wall, or as a stepping stone. The light device can plug into a standard wall outlet, be solar powered, or be battery powered.

The lighting device further includes means for electrically attaching two or more lighting devices together. In this embodiment, only one device requires a power source, with the other devices receiving power from the device that serves as the power source. Two or more lighting devices are electrically connected together via electrical prongs that can retract and extend from each side of protective cover, allowing multiple lighting devices to be connected to form a lighted walkway, patio, or other structure requiring a surface that is strong and durable. In another embodiment, the electrical connectors that can transfer power between lighting devices are attached to the base portion.

There has thus been outlined, rather broadly, features of the embodiments of the invention in order that the detailed description thereof may be better understood, and in order that the present contribution to the art may be better appreciated. There are additional features of the embodiments of the invention that will be described hereinafter and which will form the subject matter of the claims appended hereto.

### BRIEF DESCRIPTION OF THE DRAWINGS

The accompanying drawings, which are incorporated in and form a part of this specification, illustrate embodiments of the invention and together with the description, serve to explain the principals of the embodiments of the invention.

FIG. 1 shows a cross-sectional side view of the preferred embodiment of the lighting device with protective cover.

FIG. 2 shows an exploded view of the preferred embodiment of the lighting device with protective cover.

FIG. 3A shows a perspective view of the preferred embodiment of the lighting device with protective cover, with a square shaped design.

FIG. 3B shows a perspective view of the preferred embodiment of the lighting device with protective cover, with a larger square shaped design.

FIG. 3C shows a perspective view of the preferred embodiment of the lighting device with protective cover, with a rectangular shaped design.

FIG. 3D shows a perspective view of the preferred embodiment of the lighting device with protective cover, with a circular shaped design.

### DETAILED DESCRIPTION OF THE INVENTION

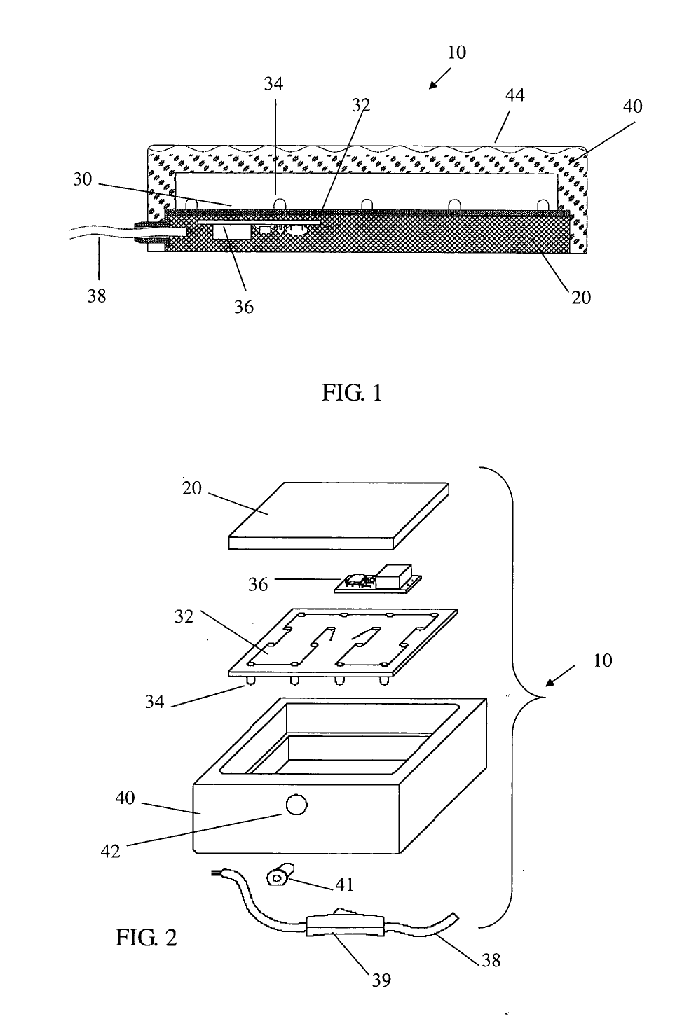

Referring now to the drawings, wherein similar parts are identified by like reference numerals, FIG. 1 shows a perspective view of the preferred embodiment of the lighting device with protective cover 10. Device 10 includes a base portion 20, a light portion 30, and a protective cover 40. Base portion 20 is preferably comprised of a strong and durable material that not electrically conductive, such as certain plastic, fiberglass, or a thick and tempered glass material. Base portion 20 can comprise various shapes such as spherical, rectangular, circular, trapezoidal, hexagonal, octagonal, triangular, square, polygonal, or other shapes as would be recognized by one with ordinary skill in the art.

Light portion 30 is preferably comprised of a circuit board 32 containing a plurality of light elements 34. Light elements 34 can be comprised of a variety of light emitting elements, including but not limited to florescent bulbs, light emitting diodes, incandescent bulbs, solar panels, and other light elements 34 as would be recognized by one with ordinary in the art. Light portion 30 also contains circuitry 36 attached to circuit board 32 to deliver power to light elements 34. Circuitry 36 can comprise various circuit elements such as resistors, capacitors, diodes, inductors, and other elements needed for power transmission. Further, circuitry 36 can include a processor, input and output blocks, and one or more memory modules that can contain programming for the processor to execute the various lighting features as described herein. Circuitry 36 preferably operates at 1 Watts and at 12 Volts. Light portion further includes a power cord 38 attached to circuitry 36. Power cord 38 is preferably configured to plug into a standard power outlet. In another embodiment, device 10 can include a battery compartment and can utilize batteries instead of electrical power from a standard wall outlet. The batteries can be NiCad, Lithium-ion, rechargeable, solar powered, or any other type of battery as recognized by one with ordinary skill in the art.

Protective cover 40 is shaped to fit around and substantially enclose base portion 20, leaving an interior region for light portion 30 to reside therein. Protective cover 40 can be shaped to fit the particular design of base portion 20. Protective cover is preferably comprised of a strong and durable material, such as the material that is used for base portion 20. Protective cover 40 is preferably comprised of a substantially translucent material, but can be comprised of any material that allows light from light portion 30 to pass through protective cover 40. Protective cover 40 preferably contains a smooth top surface 44. However, top surface 44 can include a variety of patterns, textures, and designs and still fall within the scope of the embodiments of this invention.

Device 10 can be used in a variety of applications. Device 10 can be used as an indoor light for placement on a table or desk, or device 10 can be used for a variety of outdoor purposes. For example, device 10 can be used within a walkway, a wall, or as a stepping stone. In another embodiment, particularly one suited for outdoor use of device 10, device 10 can include means for electrically attaching two or more devices 10 together. In this embodiment, only one device 10 would require a power source, with the other devices 10 receiving power from the device 10 that serves as the power source. One such iteration of this embodiment could include electrical prongs that can retract and extend from each side of protective cover 40, allowing multiple devices 10 to be connected to form a lighted walkway, patio, or other structure requiring a surface that is strong and durable.

FIG. 2 shows an exploded view of device 10, including base portion 20, light portion 30, circuit board 32, light elements 34, circuitry 36, power cord 38, and protective cover 40. As shown, power cord 38 can also include a control switch 39 located therein. Control switch 39 allows a user to turn the device 10 on or off. In other embodiments, control switch 39 also allows the user to select from different lighting features by sending signals to circuitry 36 that can change the color and/or duration of the light emitted. For example, a user can choose a steady emission of white light, a flashing emission of green light, or a combination of a steady and flashing light emission of red light, blue light, and yellow light. The user can also choose to set the light to turn on and off at various periods. For example, the user can choose to set the light to turn on for one hour, then off for an hour, then on again for another hour. In one embodiment, control switch 39 can comprise a box with a wheel device mounted substantially therein, whereby a user rotates the wheel until the wheel “clicks”, causing the device to change modes. Control switch 39 can also comprise a button, wherein multiple pushes of the button can cause the device to changes modes. Control switch 39 can also be comprised of other switch means as would be recognized by one with ordinary skill in the art.

Device 10 also includes a cord plug 41 that fits within an opening 42 in protective cover 40. Cord plug 41 helps to seal power cord 38 to device 10 such that light portion 30 is protected from water, dirt, and not exposed to cold temperatures while in an outdoor environment. Cord plug 41 is preferably circular in cross-section and can be comprised of plastic, rubber, or other materials as would be recognized by one with ordinary skill in the art.

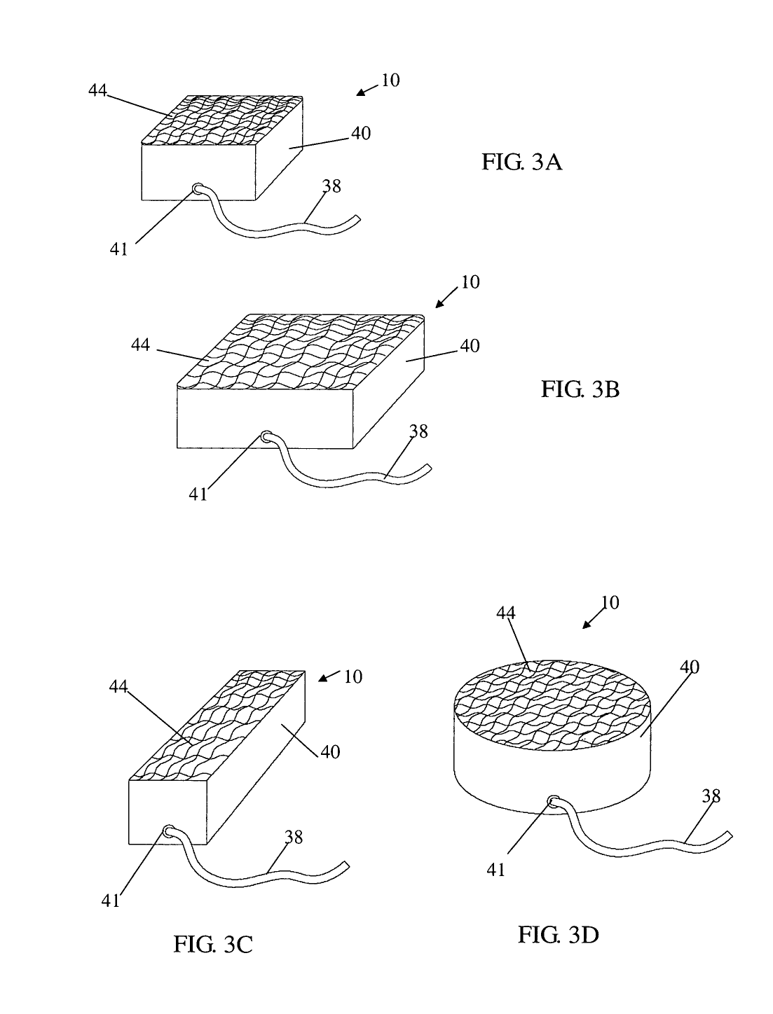

Referring now to FIGS. 3A-3D, FIG. 3A shows a perspective view of device 10 with a square shaped design, FIG. 3B shows a perspective view of device 10 with a larger square shaped design, FIG. 3C shows a perspective view of device 10 with a rectangular shaped design, and FIG. 3D shows a perspective view of device 10 with a circular shaped design. These figures are merely illustrative, and by no means exhaustive, of the shapes and designs that can encompass the invention as disclosed herein. Further, the design of the design of top surface 44 can vary from a smooth surface to a textured and contoured surface as described herein.

With respect to the above description it is to be realized that the optimum dimensional relationships for the parts of the invention, including variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described. Accordingly, all suitable modifications and equivalents fall within the scope of the present invention.

The above description, together with the various features of novelty which characterize the invention, are pointed out with particularity in the claims annexed to and forming a part of this disclosure. For a better understanding of the invention, its operating advantages and the specific advantages attained by its uses, reference should be made to the accompanying drawings and descriptive matter in which there are illustrated preferred embodiments of the invention.

Further, the purpose of the foregoing abstract is to enable the U.S. Patent and Trademark Office and the public generally, and especially the scientists, engineers, and practitioners in the art who are not familiar with patent or legal terms or phraseology, to quickly determine the nature and essence of the technical disclosure of the application. The abstract is neither intended to define the invention of the application, which is measured by the claims, nor is it intended to be limiting, as to the scope of the invention in any way.

What is claimed is:

1. A light device comprising:
a) a base portion;
b) a light portion attached to the base portion, the light portion comprising at least one light emitting element and a power supply electrically connected to the at least one light emitting element; and
c) a protective cover coupled to the base portion, the protective cover defining an interior region wherein the base portion is disposed
whereby the power supply delivers electricity to the at least one light emitting element, causing light to emit from the at least one light emitting element.

2. The light device of claim 1, wherein the light portion is removably attached to the base portion.

3. The light device of claim 1, wherein the at least one light emitting element is a light emitting diode.

4. The light device of claim 1, wherein the at least one light emitting element is a plurality of light emitting elements.

5. The light device of claim 4, wherein the plurality of light emitting elements is a plurality of light emitting diodes, each of the plurality of light emitting diodes capable of emitting a different color light.

6. The light device of claim 1, wherein the protective cover is substantially translucent.

7. The light device of claim 1, wherein the power supply is at least one solar panel.

8. The light device of claim 1, wherein the light portion further comprises a circuit board coupled to the base portion for securing the at least one light emitting element.

9. The light device of claim 1, wherein the light portion further comprises a control circuit, whereby the control circuit can vary the light emitted from the at least one light emitting element.

10. The light device of claim 9, wherein the control circuit can vary the duration of the light emitted from the at least one light emitting element.

11. The light device of claim 9, wherein the control circuit can vary the color of the light emitted from the at least one light emitting element.

12. The light device of claim 1, wherein the protective cover is comprised of a strong and durable material.

13. A light device comprising:
a) a base portion;
b) a light portion attached to the base portion, the light portion comprising a plurality of light emitting elements and a power supply electrically connected to the plurality of light emitting elements; and
c) a protective cover coupled to the base portion, the protective cover defining an interior region wherein the base portion is disposed
whereby the power supply delivers electricity to the plurality of light emitting elements, causing light to emit from the plurality of light emitting elements.

14. The light device of claim 11, wherein the plurality of light emitting elements are a plurality of light emitting diodes, each of the plurality of light emitting diodes comprising a diode capable of emitting a different color light.

15. The fiber optic light device of claim 11, wherein the power supply is electrically connected to a control circuit, whereby the control circuit can vary the color and duration of the light emitted from the plurality of light emitting elements.

16. The light device of claim 15 further comprising a control switch electrically connected to the control circuit for allowing a user to manually vary the color and duration of the light emitted from the plurality of light emitting elements.

17. The light device of claim 11 further comprising a control switch electrically connected to the power supply for allowing a user to manually turn the light device on and off.

18. The light device of claim 11, wherein the power supply is at least one solar panel.

19. A light device comprising:
a) a base portion;
b) a light portion attached to the base portion, the light portion comprising a plurality of light emitting diodes and a power supply electrically connected to the plurality of light emitting diodes;
c) a substantially translucent protective cover coupled to the base portion, the protective cover comprised of a strong and durable material for the purpose of allowing the light device to serve as a weight-bearing device, the protective cover defining an interior region wherein the base portion is disposed;
d) a control circuit electrically connected to the power supply, wherein the control circuit can vary the color and duration of the light emitted from the plurality of light emitting diodes; and
e) a control switch electrically connected to the power supply for allowing a user to manually turn the light device on and off.

20. The light device of claim 19 further comprising a control switch electrically connected to the control circuit for allowing a user to manually vary the color and duration of the light emitted from the plurality of light emitting diodes.
